(19) United States
(12) Patent Application Publication
(10) Pub. No.: US 2023/0395892 A1
(43) Pub. Date: Dec. 7, 2023

(54) Multi-layered thermal interface material structure, manufacturing method thereof, and battery device having the same

(71) Applicant: T-Global Technology Co., Ltd., Taoyuan City (TW)

(72) Inventor: Ming-Hsien Hsiao, Taoyuan City (TW)

(21) Appl. No.: 17/831,121

(22) Filed: Jun. 2, 2022

(51) Int. Cl. H01M 10/653; H01M 10/655; H01M 10/625; H01M 10/643; H01M 50/213

(52) U.S. Cl. CPC H01M 10/653; H01M 10/655; H01M 10/625; H01M 10/643; H01M 50/213

(57) ABSTRACT

A multi-layered thermal interface material (TIM) structure is adopted for being sandwiched between adjacent two rows of battery cells of a battery module. The multi-layered TIM structure includes a layer structure having a top surface and a bottom surface, of which the top surface and the bottom surface both include a plurality of concave portions. Moreover, there are two supporting mesh plates buried in the layer structure for making the layer structure simultaneously possess advantages of softness, good malleability and good support capability.

### BACKGROUND OF THE INVENTION

### 1. Field of the Invention

The present invention relates to the technology field of battery device of electric vehicle, and more particularly to a multi-layered thermal interface material structure applied to the manufacture of a battery module or a battery pack.

### 2. Description of the Prior Art

All-electric vehicles (EVs), also referred to as battery electric vehicles, comprise an electric motor instead of an internal combustion engine. The vehicle uses a large traction battery pack to power the electric motor and must be plugged in to a wall outlet or charging equipment, also called electric vehicle supply equipment (EVSE). As explained in more detail, electric vehicle battery (EVB) is the foregoing traction battery pack used to power the electric motor of a battery electric vehicle (BEV) or a hybrid electric vehicle (HEV), and the electric vehicle battery (EVB) typically designed to be a battery pack comprising a plurality of battery cells and a battery management circuit. FIG. 1 shows a perspective view of a conventional battery pack. As FIG. 1 shows, the conventional battery pack 1a, also called multi-cell battery pack, principally comprises: a plurality of battery cells 11a, a plurality of battery holders 12a and a battery management circuit 13a. In practical use, the battery pack 1a is accommodated in a housing so as to form a rechargeable battery device.

For enhancing heat dissipation efficiency of the battery pack 1a, battery manufacturer commonly fills heat conductive material in the gaps between the plurality of battery cells 11a, or disposes a heat conductive member between two adjacent battery cells. For example, China patent, publication No. CN112349998A, has disclosed a battery pack. The disclosed battery module comprises a plurality of cylindrical battery cells they are arranged into a plurality of columns and a plurality of rows. According to the disclosures of China patent, publication No. CN112349998A, any two adjacent cylindrical battery cells comprises a spacing region, and each of spacing regions is provided with a conductive rod therein, and a conductive filler is filled in the other spacing regions.

Therefore, it is understood that the conventional battery pack disclosed by China patent, publication No. CN112349998A, comprises some drawbacks summarized in follows.
(1) When manufacturing the battery pack, it needs to dispose the multiple battery cells in an accommodating base and space them evenly. After that, it needs to dispose multiple heat conductive rods into the spacing regions, and to fill conductive fillers in the remaining spacing regions. In a word, the conventional battery pack needs a complicated manufacturing procedure.
(2) the manufacturing process error of the battery cells and/or the heat conductive rods causes some heat conductive rods fail to be embedded into the corresponding spacing regions, resulting in the manufacture failure of the battery pack.

According to above descriptions, it is understood that there are rooms for improvement in the conventional heat dissipation solution applied to the manufacture of battery packs. In view of that, the inventors of the present application have made great efforts to make inventive research and eventually provided a multi-layered thermal interface material structure applied to the manufacture of a battery module or a battery pack.

### SUMMARY OF THE INVENTION

The primary objective of the present invention is to disclose a multi-layered thermal interface material (TIM) structure for application in a battery module, so as to make the multi-layered TIM structure be sandwiched between adjacent two rows of battery cells of the battery module. According to the present invention, a layer structure comprising a top surface and a bottom surface is manufactured according to a plurality of gaps existing in the two adjacent rows of battery cells, such that the top surface and the bottom surface both comprise a plurality of concave portions. Particularly, there are two supporting mesh plates buried in the layer structure for making the layer structure simultaneously possess advantages of softness, malleability and good support capability. Therefore, when this multi-layered TIM structure is adopted in assembling N rows of battery cells to become a battery module, the multi-layered TIM structure is firstly stacked on a first row of battery cells, and then a second row of battery cells is tacked on the multi-layered TIM structure. Subsequently, another multi-layered TIM structure is stacked on the second row of battery cells, and then a third row of battery cells is tacked on the multi-layered TIM structure. And so on, (N−1) layers of the multi-layered TIM structure and N rows of battery cells are therefore assembled to form one battery module.

For achieving the primary objective mentioned above, the present invention provides an embodiment of the multi-layered thermal interface material structure, comprising:
a layer structure comprising a body thickness, comprising an upper layer and a lower layer both made of a first thermal interface material, and further comprising a middle layer made of a second thermal interface material, wherein the middle layer is stacked between the upper layer and the lower layer;
a first supporting mesh plate, being buried in the lower layer, comprising a plate thickness that is smaller than the body thickness, and comprising a plurality of pores; and
a second supporting mesh plate, being buried in the upper layer, and also comprising the plate thickness and the plurality of pores;
wherein the middle layer is located between the first supporting mesh plate and the second supporting mesh plate;
wherein the layer structure comprises a top surface and a bottom surface, and the top surface and the bottom surface both comprising a plurality of concave portions.

In one embodiment, the body thickness is in a range between 0.2 mm and 30 mm, and the plate thickness being in a range between 0.01 mm and 20 mm.

In one embodiment, the first supporting mesh plate and the second supporting mesh plate are both made of at least one material selected from a group consisting of fiberglass, carbon fiber, polyvinylamine, carbon steel, stainless steel, copper alloy, and aluminum alloy, and the pore comprising a sieve size in a range between 10 supporting mesh and 200 supporting mesh.

In one embodiment, the first thermal interface material comprises a first polymer matrix and a plurality of first thermal conductive filler distributed in the first polymer matrix.

In one embodiment, the second thermal interface material comprises a second polymer matrix and a plurality of second thermal conductive filler distributed in the second polymer matrix, wherein the second thermal conductive filler comprises metal particles, ceramic particles and at least one selected from a group consisting of metal oxide particles, nitride particles, carbide particles, diboride particles, and graphite particles, and the ceramic particle comprises a particle size smaller than a sieve size of the pore, such that the ceramic particles are confined in the middle layer by the first supporting mesh plate and the second supporting mesh plate.

In one embodiment, the top surface and the bottom surface are both provided with a heat conductive protection layer thereon, and the heat conductive protection layer is made of a material selected from a group consisting of paraffin, epoxy resin, polyurethane, silicone, rubber, polypropylene, and thermally conductive phase change material.

In one embodiment, the layer structure comprises a first hardness, and the heat conductive protection layer comprises a second hardness that is greater than the first hardness.

Moreover, the present invention also provides a multi-layered thermal interface material structure manufacturing method, comprising the steps of:
(1) providing a first mould comprising a first moulding recess, wherein a bottom surface of the first moulding recess is formed with M units of first protrusion member, M being an integer, and each of the first protrusion members comprising a convex surface;
(2) filling a first thermal interface material into the first moulding recess;
(3) disposing a first supporting mesh plate in the first moulding recess;
(4) filling a second thermal interface material into the first moulding recess, and being positioned on the first supporting mesh plate;
(5) disposing a second supporting mesh plate on the second thermal interface material;
(6) filling a third thermal interface material into the first moulding recess, and being positioned on the second supporting mesh plate;
(7) providing a second mould comprising a second moulding recess, wherein a bottom surface of the second moulding recess is formed with M units of second protrusion member, and each of the second protrusion members comprising a convex surface;
(8) stacking the second mould on the first mould, so as to make the second moulding recess receive the third thermal interface material;
(9) curing the first thermal interface material, the second thermal interface material and the thermal interface material to become a layer structure; and
(10) demoulding the second mould and the first mould, thereby obtaining a thermal interface material structure.

In one embodiment, the first thermal interface material and the third thermal interface material both comprise a first polymer matrix and a plurality of first thermal conductive filler distributed in the polymer matrix.

In one embodiment, the second thermal interface material comprises a second polymer matrix and a plurality of second thermal conductive filler distributed in the second polymer matrix, wherein the second thermal conductive filler comprises metal particles, ceramic particles and at least one selected from a group consisting of metal oxide particles, nitride particles, carbide particles, diboride particles, and graphite particles, and the ceramic particle comprising a particle size smaller than a sieve size of the pore, such that the ceramic particles are confined in the middle layer by the first supporting mesh plate and the second supporting mesh plate.

In one embodiment, there is a specific percent of the plurality of second thermal conductive filler comprises a particle size greater than the sieve size of the pore, and the specific percent is in range between 20% and 60%.

In one embodiment, there is a specific percent of the plurality of first thermal conductive filler comprises a particle size smaller than the sieve size of the pore, and the specific percent is in range between 60% and 90%.

In one embodiment, the layer structure comprises a top surface and a bottom surface, the surface and the bottom surface both comprising a plurality of concave portions.

In one embodiment, the top surface and the bottom surface are both provided with a heat conductive protection layer thereon, and the heat conductive protection layer being made of a material selected from a group consisting of paraffin, epoxy resin, polyurethane, silicone, rubber, polypropylene, and thermally conductive phase change material. The layer structure comprises a first hardness, and the heat conductive protection layer comprises a second hardness that is greater than the first hardness.

Furthermore, the present invention also provides a battery device, which is a battery pack or a battery module, and is characterized in that: comprising the foregoing thermal interface material structure.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a perspective view of a conventional battery pack;

FIG. 2 shows a perspective view of a battery device comprising a multi-layered thermal interface material structure according to the present invention;

FIG. 3 shows an exploded view of the battery device;

FIG. 4 shows an exploded view of the multi-layered thermal interface material structure according to the present invention;

FIG. 5 shows a sectional view of the multi-layered thermal interface material structure according to the present invention;

FIG. 6A and FIG. 6B show flowcharts of a multi-layered thermal interface material structure manufacturing method according to the present invention;

FIG. 7A, FIG. 7B and FIG. 7C show diagrams for describing manufacturing processes of the multi-layered thermal interface material structure;

FIG. 8 shows a flowchart of a battery device manufacturing method according to the present invention;

FIG. 9 shows a diagram for describing manufacturing processes of a battery device; and

FIG. 10 shows a diagram for describing how to assembly a battery device.

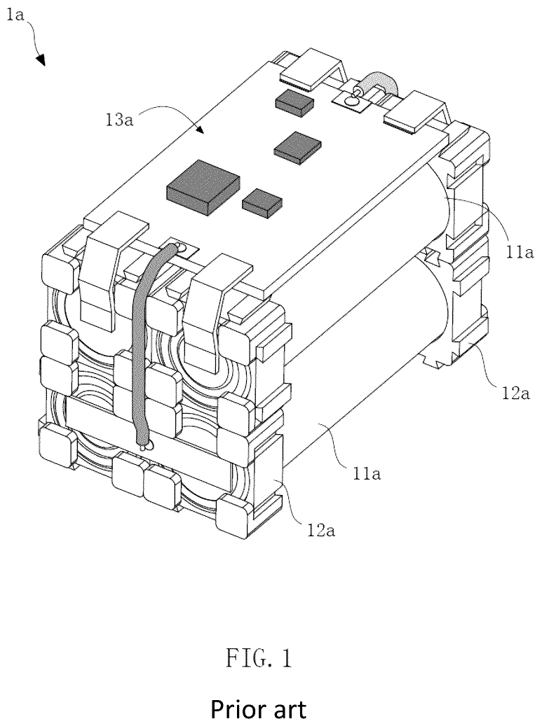

### DETAILED DESCRIPTION OF THE PREFERRED EMBODIMENTS

To more clearly describe a multi-layered thermal interface material structure applied to the manufacture of a battery module or a battery pack according to the present invention, embodiments of the present invention will be described in detail with reference to the attached drawings hereinafter.

Multi-layered thermal interface material structure and battery device comprising the same are provided.

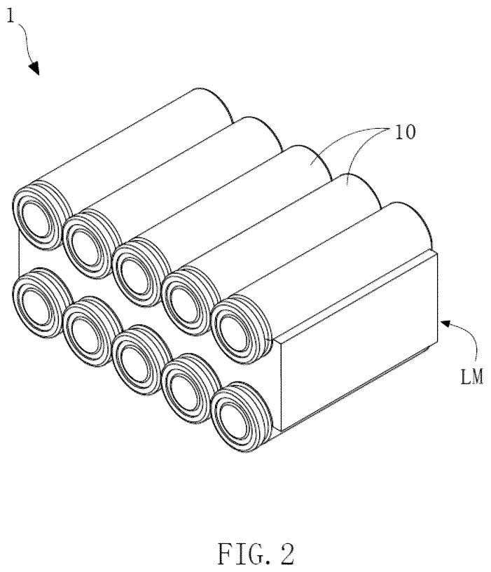

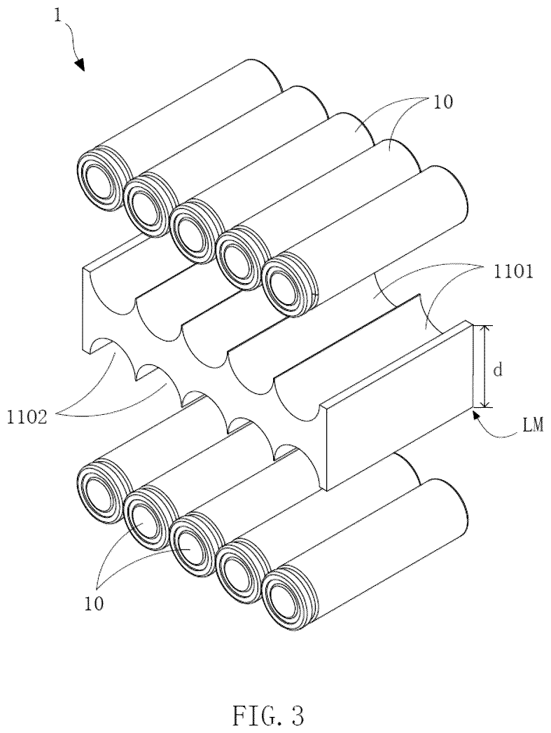

With reference to FIG. 2, it shows a perspective view of a battery device comprising a multi-layered thermal interface material structure according to the present invention. Moreover, FIG. 3 shows an exploded view of the battery device. As FIG. 2 and FIG. 3 show, the present invention discloses a multi-layered thermal interface material (TIM) structure 11 for application in a battery device 1, so as to make the multi-layered TIM structure 11 be sandwiched between two adjacent rows of battery cells 10 of the battery device 1. As explained in more detail below, when manufacturing the battery device 1, multiple battery cells 10 are firstly assembled to be a battery module (i.e. a row of battery cells 10), and then at least one battery module and a battery management circuit are integrated to become the battery device 1.

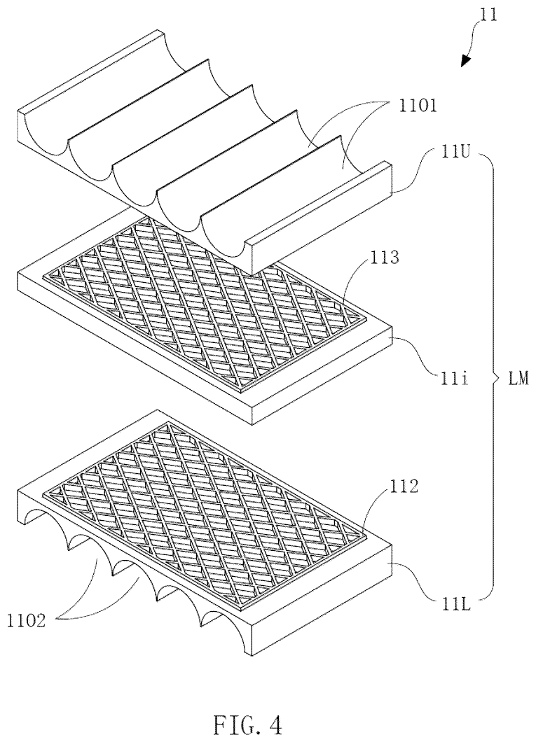

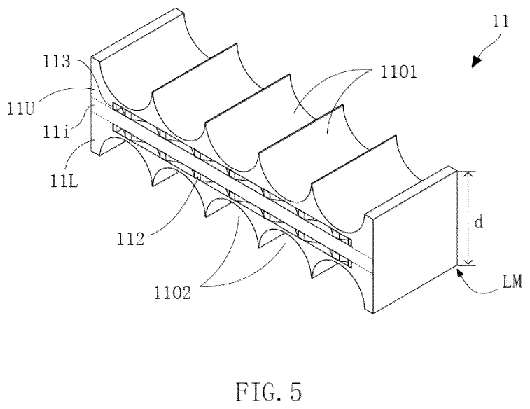

FIG. 4 shows an exploded view of the thermal interface material structure according to the present invention. Moreover, FIG. 5 shows a sectional view of the thermal interface material structure according to the present invention. As FIG. 3, FIG. 4 and FIG. 5 show, the multi-layered TIM structure 11 comprises a layer structure LM, a first supporting mesh plate 112, and a second supporting mesh plate 113. In which, the layer structure LM comprises a body thickness (i.e., d), and comprises an upper layer 11U and a lower layer 11L both made of a first thermal interface material. Moreover, the layer structure LM further comprises a middle layer made 11i of a second thermal interface material, wherein the middle layer 11i is stacked between the upper layer 11U and the lower layer 11L. As described in more detail below, the first supporting mesh plate and the second supporting mesh plate both comprise a plate thickness and a plurality of pores, wherein the plate thickness is smaller than the body thickness.

In one embodiment, the first supporting mesh plate 112 is buried in the lower layer 11L, and the second supporting mesh plate 113 is buried in the upper layer 11U, such that the middle layer 11i is located between the first supporting mesh plate 112 and the second supporting mesh plate 113. In addition, the body thickness is in range between 0.2 mm and 30 mm, and the plate thickness is in range between 0.01 mm and 20 mm.

According to the present invention, the layer structure LM comprises a top surface and a bottom surface, and the top surface and the bottom surface both comprise M units of concave portion 11O. Moreover, because the battery cell 10 is a cylindrical battery cell, such that the concave portion 11O is designed to comprise a curvature radius so as to match the cylindrical battery cell 10.

In one embodiment, the first supporting mesh plate 112 and the second supporting mesh plate 113 can both be made of fiberglass, carbon fiber, polyvinylamine, carbon steel, stainless steel, copper alloy, aluminum alloy, or a combination of any two or more of the foregoing. On the other hand, the upper layer 11U and the lower layer 11L are both made of a first thermal interface material comprising a first polymer matrix and a plurality of first thermal conductive filler distributed in the first polymer matrix. According to the disclosures of China patent, publication No. CN101351755A, the first thermal conductive filler can be metal oxide particles, nitride particles, carbide particles, diboride particles, graphite particles, metal particles, or a combination of any two or more of the foregoing. However, in a specific embodiment, the first polymer matrix is thermoplastic polyurethane (TPU).

On the other hand, the middle layer 11i is made of a second thermal interface material comprising a second polymer matrix and a plurality of second thermal conductive filler distributed in the second polymer matrix. According to the present invention, the second thermal conductive filler comprises metal particles, ceramic particles and at least one selected from a group consisting of metal oxide particles, nitride particles, carbide particles, diboride particles, and graphite particles, and the ceramic particle comprises a particle size smaller than a sieve size of the pore, such that the ceramic particles are confined in the middle layer 11i by the first supporting mesh plate 112 and the second supporting mesh plate 113. Herein, it is worth further explaining that, there is a specific percent of the plurality of second thermal conductive filler comprises a particle size greater than the sieve size of the pore, and the specific percent is in range between 20% and 60%. Moreover, there is a specific percent of the plurality of first thermal conductive filler comprises a particle size smaller than the sieve size of the pore, and the specific percent is in range between 60% and 90%.

Furthermore, in a practicable embodiment, the top surface and the bottom surface are both provided with a heat conductive protection layer thereon, and the heat conductive protection layer is made of paraffin, epoxy resin, polyurethane, silicone, rubber, polypropylene, thermally conductive phase change material, or a combination of any two or more of the foregoing. As such, the layer structure LM comprises a first hardness, and the heat conductive protection layer comprises a second hardness that is greater than the first hardness. In addition, it can be further mixed with a ceramic filler within the heat conductive protection layer, and the ceramic filler can be alumina, magnesium oxide, zinc oxide, zirconium oxide, aluminum nitride, boron nitride, or silicon nitride. Moreover, it can also be further mixed with a carbon-based filler within the heat conductive protection layer, and the carbon-based filler can be graphite, graphene, silicon carbide, tungsten carbide, carbon nanotubes, graphite, carbon black.

In brief, the present invention discloses a multi-layered thermal interface material (TIM) structure 11 for application in a battery device 1, so as to make the TIM structure 11 be sandwiched between adjacent rows of battery cells 10 of the battery device 1. According to the present invention, the layer structure LM of the multi-layered TIM structure 11 comprising a top surface and a bottom surface is manufactured according to a plurality of gaps existing in the two adjacent rows of battery cells 10, such that the top surface and the bottom surface both comprise a plurality of concave portions 11O. Particularly, there are a first supporting mesh plate 112 and a second supporting mesh plate 113 buried in the layer structure LM for making the layer structure LM simultaneously possess advantages of softness, malleability and good support capability.

By such arrangement, when this multi-layered TIM structure 11 is adopted in assembling N rows of battery cells 10 to become the battery device 1, the multi-layered TIM structure 11 is firstly stacked on a first row of battery cells 10 (i.e., one battery module consisting of a row of battery cells 10), and then a second row of battery cells 10 (i.e., another battery module consisting of a row of battery cells 10) is tacked on the multi-layered TIM structure 11. Subsequently, another multi-layered TIM structure 11 is firstly stacked on the second row of battery cells 10, and then a third row of battery cells 10 is tacked on the multi-layered TIM structure 11. And so on, N−1 numbers of the multi-layered TIM structure 11 and N rows of battery cells are therefore assembled to one battery device 1. Herein, it is worth explained that, two adjacent battery cells 10 are spaced by a gap, and two adjacent concave portions 11O are connected by a protuberance spacer, such that the protuberance spacer is embedded into the gap after the M pieces of battery cell 10 are disposed on the plurality of concave portions 11O.

The method for manufacturing multi-layered TIM structure is provided.

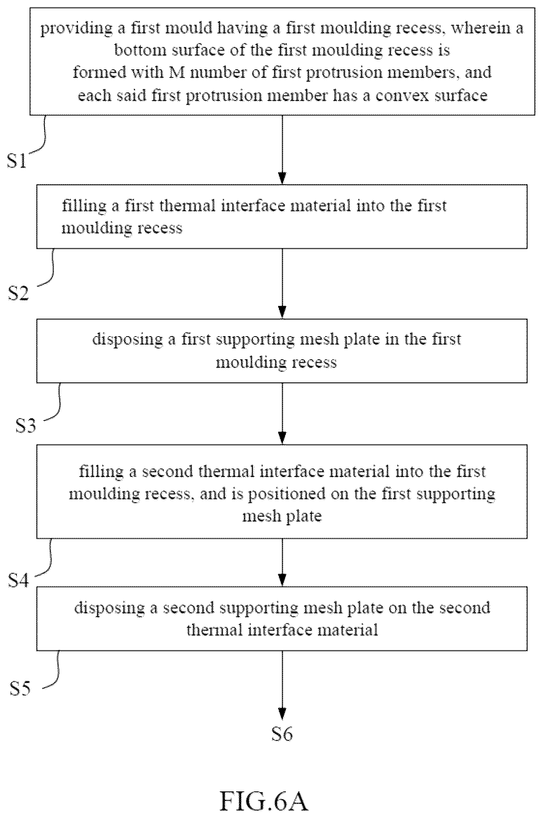

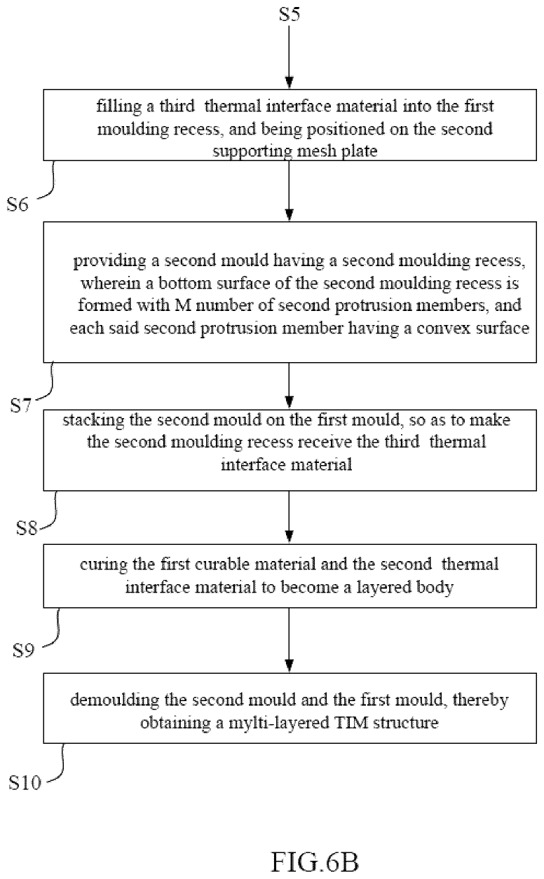

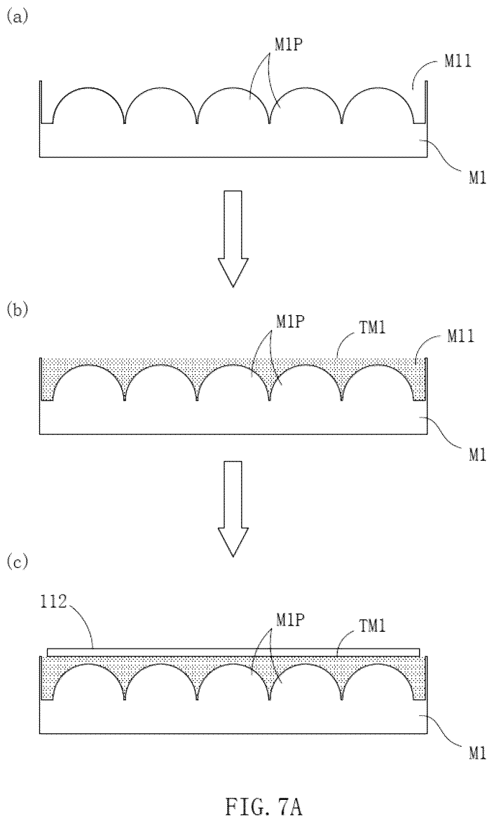

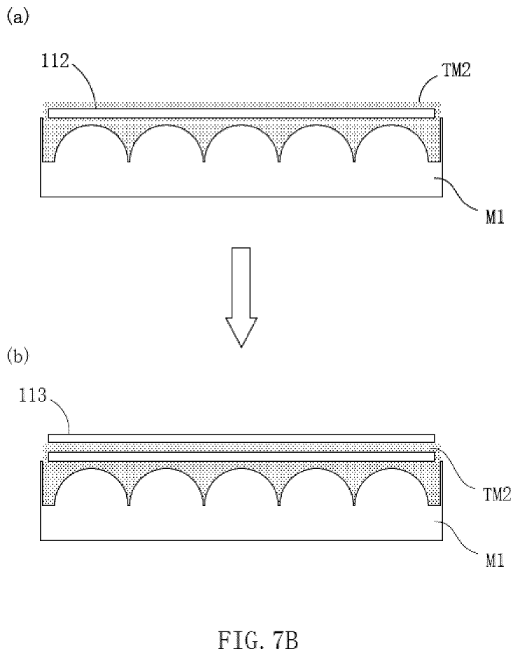

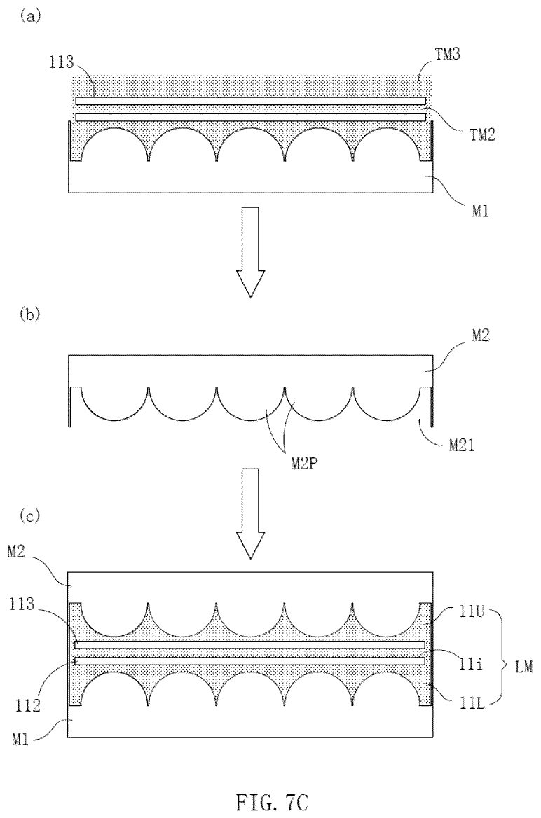

With reference to FIG. 6A and FIG. 6B, there are flowcharts of a multi-layered TIM structure manufacturing method according to the present invention. Moreover, FIG. 7A and FIG. 7B are diagrams for describing manufacturing processes of the multi-layered TIM structure. According to FIG. 6A and the manufacturing process diagram (a) shown in FIG. 7A, the method firstly proceeds to step S1, so as to provide a first mould M1 comprising a first moulding recess M11. In which, a bottom surface of the first moulding recess is formed with M units of first protrusion member M1P, M is an integer, and each of the first protrusion members M1P comprises a convex surface. According to FIG. 6A and the manufacturing process diagram (b) shown in FIG. 7A, the method subsequently proceeds to step S2. In step S2, a first thermal interface material TM1 is filled in the first moulding recess M11. Moreover, according to FIG. 6A and the manufacturing process diagram (c) shown in FIG. 7A, a first supporting mesh plate 112 is disposed in the first moulding recess M11 after step S3 is completed.

According to FIG. 6A and the manufacturing process diagrams (a)-(b) shown in FIG. 7B, the method subsequently proceeds to steps S4-S5, such that a second thermal interface material TM2 is filled in the first moulding recess M11 to be positioned on the first supporting mesh plate 112, and then a second supporting mesh plate 113 is disposed on the second thermal interface material TM2. After that, according to FIG. 6B and the manufacturing process diagrams (a)-(b) shown in FIG. 7C, the method subsequently proceeds to steps S6-S7. In step S6, a third thermal interface material TM3 is filled in the first moulding recess M11 so as to be positioned on the second supporting mesh plate 113. Moreover, there is provided a second mould M2 comprising a second moulding recess M21 in step S7. As FIG. 7C shows, a bottom surface of the second moulding recess M21 is formed with M units of second protrusion member M2P, and each of the second protrusion members M2P comprises a convex surface.

According to FIG. 6B and the manufacturing process diagram (c) shown in FIG. 7C, the method subsequently proceeds to step S8, such that the second mould M2 is stacked on the first mould M1, thereby making the second moulding recess M21 receive the third thermal interface material TM3. As a result, after curing the first thermal interface material TM1, the second thermal interface material TM2 and the third thermal interface material TM 3 to become a layer structure LM by completing step S9, it is able to obtain a multi-layered TIM structure 11 by demoulding the second mould M2 and the first mould M1 (i.e., completing step S10).

It is worth further explaining that, the first thermal interface material TM1 and the third thermal interface material TM2 both comprise a first polymer matrix and a plurality of first thermal conductive filler distributed in the first polymer matrix. In which, the first thermal conductive filler comprises a plurality of particles, and the particles can be metal oxide particles, nitride particles, carbide particles, diboride particles, graphite particles, metal particles, or a combination of any two or more of the foregoing. However, in a specific embodiment, the first polymer matrix is thermoplastic polyurethane (TPU).

On the other hand, the third thermal interface material TM3 comprises a second polymer matrix and a plurality of second thermal conductive filler distributed in the second polymer matrix. According to the present invention, the second thermal conductive filler comprises metal particles, ceramic particles and at least one selected from a group consisting of metal oxide particles, nitride particles, carbide particles, diboride particles, and graphite particles, and the ceramic particle comprises a particle size smaller than a sieve size of the pore, such that the ceramic particles are confined in the middle layer 11i by the first supporting mesh plate 112 and the second supporting mesh plate 113. Herein, it is worth further explaining that, there is a specific percent of the plurality of second thermal conductive filler comprises a particle size greater than the sieve size of the pore, and the specific percent is in range between 20% and 60%. Moreover, there is a specific percent of the plurality of first thermal conductive filler comprises a particle size smaller than the sieve size of the pore, and the specific percent is in range between 60% and 90%.

According to FIGS. 7A-FIG. 7C, it should be understood that, the first mould M1 and the second mould M2 are used to build up the layer structure LM. Therefore, the first polymer matrix and the second polymer matrix are both selected from a group consisting of thermosetting polymer, photocurable polymer and mixture of polymer and curing agent.

Furthermore, it is worth explaining that, the first supporting mesh plate 112 and the second supporting mesh plate 113 are both made of at least one material selected from a group consisting of fiberglass, carbon fiber, polyvinylamine, carbon steel, stainless steel, copper alloy, and aluminum alloy, and the pore comprising a sieve size in a range between 10 supporting mesh and 200 supporting mesh. By such arrangement, after the multi-layered TIM structure 11 is made by completing the steps S1-S10, the middle layer 11i is located between the first supporting mesh plate 112 and the second supporting mesh plate 113, and each of the pores of the first supporting mesh plate 113 and the second supporting mesh plate 113 is fully filled with the thermal interface material.

Moreover, the top surface and the bottom surface of the layer structure LM with a heat conductive protection layer thereon. In one embodiment, the heat conductive protection layer is made of a material, and the material can be paraffin, epoxy resin, polyurethane, silicone, rubber, polypropylene, thermally conductive phase change material, or a combination of any two or more of the foregoing. As such, the layer structure LM comprises a first hardness, and the heat conductive protection layer comprises a second hardness that is greater than the first hardness.

The method for manufacturing battery device is provided.

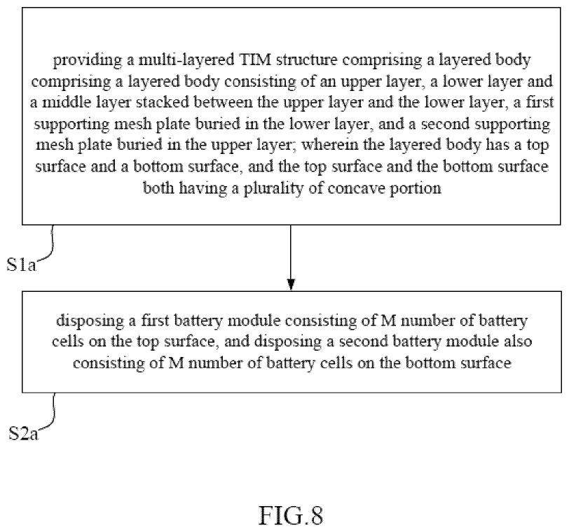

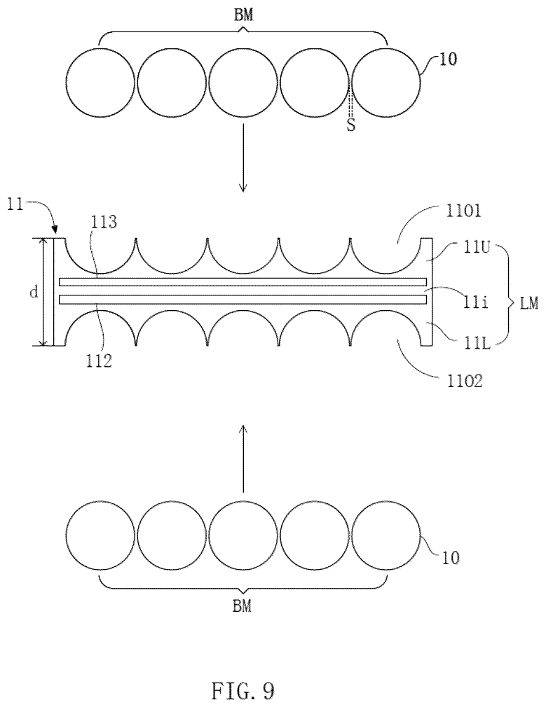

With reference to FIG. 8, there is shown a flowchart of a battery device manufacturing method according to the present invention. Moreover, FIG. 9 is a diagram for describing manufacturing processes of a battery device. As FIGS. 8 and FIG. 9 show, the method firstly proceeds to step S1a, so as to provide a multi-layered TIM structure 11 comprising a layer structure LM that consists of an upper layer 11U, a lower layer 11L and a middle layer 11i stacked between the upper layer 11U and the lower layer 11L, a first supporting mesh plate 112 buried in the lower layer 11L, and a second supporting mesh plate 113 buried in the upper layer 11U. In which, the layer structure LM comprises a top surface and a bottom surface, and the top surface and the bottom surface both comprising a plurality of concave portions 11O. Then, the method subsequently proceeds to step S2a, so as to dispose a first battery module BM1 consisting of M pieces of battery cell 10 on the top surface, and to dispose a second battery module BM2 also consisting of M pieces of battery cell 10 on the bottom surface, wherein M is an integer.

As FIG. 9 shows, two adjacent battery cells 10 are spaced by a gap S, and two adjacent concave portions 11O are connected by a protuberance spacer P, such that the protuberance spacer p is embedded into the gap S after the M pieces of battery cell 10 are disposed on the plurality of concave portions 11O. According to above descriptions, it is known that the top surface and the bottom surface are both provided with a heat conductive protection layer thereon, the layer structure LM comprises a first hardness, and the heat conductive protection layer comprises a second hardness that is greater than the first hardness. Therefore, during the manufacturing processes of the battery device 1, the heat conductive protection layer is heated by the first battery module BM1 and/or the second battery module BM2, such that the second hardness is adjusted to be lowered, thereby approaching the first hardness. Of course, the heat conductive protection layer can also be heated by an external heat source during the manufacturing processes of the battery device 1.

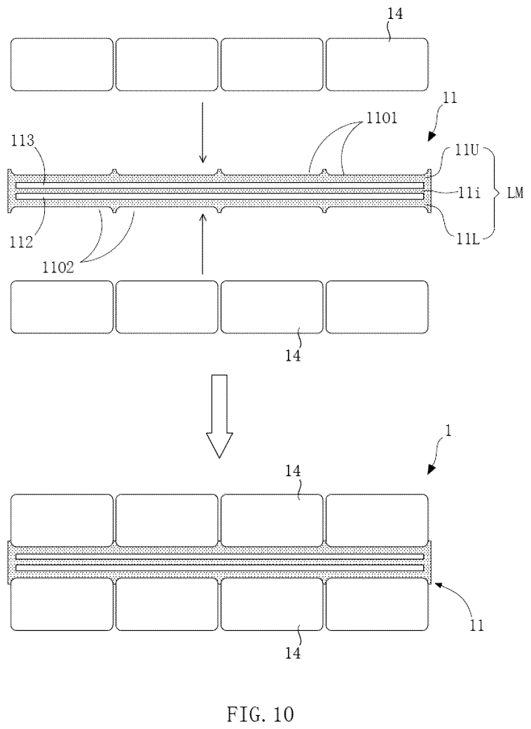

On the other hand, FIG. 10 shows a diagram for describing how to assembly a battery device. As FIG. 8 and FIG. 10 show, the battery device manufacturing method can also be adopted for manufacturing a specific battery device 1 comprising two battery module (BM1a, BM2a) and one multi-layered TIM structure 11, of which the battery module consists of M pieces of prismatic battery cell. The method firstly proceeds to step S1a, so as to provide a multi-layered TIM structure 11 comprising a layer structure LM that consists of an upper layer 11U, a lower layer 11L and a middle layer 11i, a first supporting mesh plate 112 buried in the lower layer 11L, and a second supporting mesh plate 113 buried in the upper layer 11U. In which, the layer structure LM comprises a top surface and a bottom surface, and the top surface and the bottom surface both comprising a plurality of concave portions 11O. Then, the method subsequently proceeds to step S2a, so as to dispose a first battery module BM1a consisting of M pieces of prismatic battery cell 14 on the top surface, and to dispose a second battery module BM2a also consisting of M pieces of prismatic battery cell 14 on the bottom surface, wherein M is an integer. As FIG. 10 shows, two adjacent prismatic battery cells 14 are spaced by a gap S, and two adjacent concave portions 11O are connected by a protuberance spacer P, such that the protuberance spacer p is embedded into the gap S after the M pieces of prismatic battery cell 10 are disposed on the plurality of concave portions 11O.

Therefore, through the above descriptions, all embodiments of the thermal interface material coating method for battery cells according to the present invention have been introduced completely and clearly. Moreover, the above description is made on embodiments of the present invention. However, the embodiments are not intended to limit the scope of the present invention, and all equivalent implementations or alterations within the spirit of the present invention still fall within the scope of the present invention.

What is claimed is:

1. A multi-layered thermal interface material structure, comprising:
a layer structure comprising a body thickness, comprising an upper layer and a lower layer both made of a first thermal interface material, and further comprising a middle layer made of a second thermal interface material, wherein the middle layer is stacked between the upper layer and the lower layer;
a first supporting mesh plate, being buried in the lower layer, comprising a plate thickness that is smaller than the body thickness, and comprising a plurality of pores; and
a second supporting mesh plate, being buried in the upper layer, and also comprising the plate thickness and the plurality of pores;
wherein the middle layer is located between the first supporting mesh plate and the second supporting mesh plate;
wherein the layer structure comprises a top surface and a bottom surface, and the top surface and the bottom surface both comprising a plurality of concave portions.

2. The multi-layered thermal interface material structure of claim 1, wherein the body thickness is in range between 0.2 mm and 30 mm, and the plate thickness being in range between 0.01 mm and 20 mm.

3. The multi-layered thermal interface material structure of claim 1, wherein the first supporting mesh plate and the second supporting mesh plate are both made of at least one material selected from a group consisting of fiberglass, carbon fiber, polyvinylamine, carbon steel, stainless steel, copper alloy, and aluminum alloy.

4. The multi-layered thermal interface material structure of claim 1, wherein the first thermal interface material comprises a first polymer matrix and a plurality of first thermal conductive filler distributed in the first polymer matrix.

5. The multi-layered thermal interface material structure of claim 4, wherein the first polymer matrix is thermoplastic polyurethane (TPU), and the first thermal conductive filler comprising at least one selected from a group consisting of metal oxide particles, nitride particles, carbide particles, diboride particles, graphite particles, and metal particles.

6. The multi-layered thermal interface material structure of claim 4, wherein the second thermal interface material comprises a second polymer matrix and a plurality of second thermal conductive filler distributed in the second polymer matrix, wherein the second thermal conductive filler comprises metal particles, ceramic particles and at least one selected from a group consisting of metal oxide particles, nitride particles, carbide particles, diboride particles, and graphite particles, and the ceramic particle comprising a particle size smaller than a sieve size of the pore, such that the ceramic particles are confined in the middle layer by the first supporting mesh plate and the second supporting mesh plate.

7. The multi-layered thermal interface material structure of claim 1, wherein the top surface and the bottom surface are both provided with a heat conductive protection layer thereon, and the heat conductive protection layer being made of a material selected from a group consisting of paraffin, epoxy resin, polyurethane, silicone, rubber, polypropylene, and thermally conductive phase change material.

8. The multi-layered thermal interface material structure of claim 7, wherein the layer structure comprises a first hardness, and the heat conductive protection layer comprising a second hardness that is greater than the first hardness.

9. A battery device, being selected from a group consisting of battery pack and battery module, and being characterized in that the battery device comprises a multi-layered thermal interface material structure, comprising:
a layer structure comprising a body thickness, comprising an upper layer and a lower layer both made of a first thermal interface material, and further comprising a middle layer made of a second thermal interface material, wherein the middle layer is stacked between the upper layer and the lower layer;
a first supporting mesh plate, being buried in the lower layer, comprising a plate thickness that is smaller than the body thickness, and comprising a plurality of pores; and
a second supporting mesh plate, being buried in the upper layer, and also comprising the plate thickness and the plurality of pores;
wherein the middle layer is located between the first supporting mesh plate and the second supporting mesh plate;
wherein the layer structure comprises a top surface and a bottom surface, and the top surface and the bottom surface both comprising a plurality of concave portions.

10. A multi-layered thermal interface material structure manufacturing method, comprising the steps of:
(1) providing a first mould comprising a first moulding recess, wherein a bottom surface of the first moulding recess is formed with M units of first protrusion member, M being an integer, and each of the first protrusion members comprising a convex surface;
(2) filling a first thermal interface material into the first moulding recess;
(3) disposing a first supporting mesh plate in the first moulding recess;
(4) filling a second thermal interface material into the first moulding recess, and being positioned on the first supporting mesh plate;
(5) disposing a second supporting mesh plate on the second thermal interface material;
(6) filling a third thermal interface material into the first moulding recess, and being positioned on the second supporting mesh plate;
(7) providing a second mould comprising a second moulding recess, wherein a bottom surface of the second moulding recess is formed with M units of second protrusion member, and each of the second protrusion members comprising a convex surface;
(8) stacking the second mould on the first mould, so as to make the second moulding recess receive the third thermal interface material;
(9) curing the first thermal interface material, the second thermal interface material and the thermal interface material to become a layer structure; and
(10) demoulding the second mould and the first mould, thereby obtaining a multi-layered thermal interface material structure.

11. The multi-layered thermal interface material structure manufacturing method of claim 10, the first thermal interface material and the third thermal interface material both comprise a first polymer matrix and a plurality of first thermal conductive filler distributed in the polymer matrix.

12. The multi-layered thermal interface material structure manufacturing method of claim 11, wherein the first polymer matrix is thermoplastic polyurethane (TPU), and the first thermal conductive filler comprising at least one selected from a group consisting of metal oxide particles, nitride particles, carbide particles, diboride particles, graphite particles, and metal particles.

13. The multi-layered thermal interface material structure manufacturing method of claim 11, wherein the second thermal interface material comprises a second polymer matrix and a plurality of second thermal conductive filler distributed in the second polymer matrix, wherein the second thermal conductive filler comprises metal particles, ceramic particles and at least one selected from a group consisting of metal oxide particles, nitride particles, carbide particles, diboride particles, and graphite particles, and the ceramic particle comprising a particle size smaller than a sieve size of the pore, such that the ceramic particles are confined in the middle layer by the first supporting mesh plate and the second supporting mesh plate.

14. The multi-layered thermal interface material structure manufacturing method of claim 13, wherein there is a specific percent of the plurality of second thermal conductive filler comprises a particle size greater than the sieve size of the pore, and the specific percent being in range between 20% and 60%.

15. The multi-layered thermal interface material structure manufacturing method of claim 14, wherein there is a specific percent of the plurality of first thermal conductive filler comprises a particle size smaller than the sieve size of the pore, and the specific percent being in range between 60% and 90%.

16. The multi-layered thermal interface material structure manufacturing method of claim 13, wherein the first polymer matrix and the second polymer matrix are both selected from a group consisting of thermosetting polymer, photocurable polymer and mixture of polymer and curing agent.

17. The multi-layered thermal interface material structure manufacturing method of claim 10, wherein the top surface and the bottom surface are both provided with a heat conductive protection layer thereon, and the heat conductive protection layer being made of a material selected from a group consisting of paraffin, epoxy resin, polyurethane, silicone, rubber, polypropylene, and thermally conductive phase change material.

18. A battery device manufacturing method, comprising the steps of:
providing a multi-layered thermal interface material structure comprising a layer structure comprising a layer structure consisting of an upper layer, a lower layer and a middle layer stacked between the upper layer and the lower layer, a first supporting mesh plate buried in the lower layer, and a second supporting mesh plate buried in the upper layer; wherein the layer structure comprises a top surface and a bottom surface, and the top surface and the bottom surface both comprising a plurality of concave portions; and
disposing a first battery module consisting of M pieces of battery cell on the top surface, and disposing a second battery module also consisting of M pieces of battery cell on the bottom surface, wherein M is an integer.

19. The battery device manufacturing method of claim 18, wherein two adjacent battery cells are spaced by a gap, and two adjacent concave portions being connected by a protuberance spacer, such that the protuberance spacer is embedded into the gap after the M pieces of battery cell are disposed on the plurality of concave portions.

20. The battery device manufacturing method of claim 18, wherein the top surface and the bottom surface are both provided with a heat conductive protection layer thereon, the layer structure comprising a first hardness, and the heat conductive protection layer comprising a second hardness that is greater than the first hardness.

21. The battery device manufacturing method of claim 20, wherein the layer structure comprises a body thickness in range between 0.2 mm and 30 mm.

22. The battery device manufacturing method of claim 18, wherein the supporting mesh plate comprising a plate thickness in range between 0.01 mm and 20 mm.

23. A thermal interface material structure, comprising:
a layer structure, comprising a thermal interface material;
a plurality of thermal conductive fillers, distributed in the layer structure;
a supporting mesh plate, buried in the layer structure, at least comprising a seize size, wherein 40%-90% of the thermal conductive fillers is greater than the seize size.
